(19) United States
(12) Patent Application Publication
(10) Pub. No.: US 2013/0003517 A1
(43) Pub. Date: Jan. 3, 2013

(54) OPTICAL PICKUP DEVICE, OPTICAL DISC APPARATUS, AND INFORMATION RECORDING METHOD

(76) Inventor: Kazuyoshi YAMAZAKI, Yamato (JP)

(21) Appl. No.: 13/532,816

(22) Filed: Jun. 26, 2012

(30) Foreign Application Priority Data
Jun. 29, 2011 (JP) 2011-144327

(51) Int. Cl. G11B 7/00

(52) U.S. Cl. 369/112.23; G9B/7

(57) ABSTRACT

An optical pickup device and an optical disc apparatus including the optical pickup device are provided which can obtain a stable servo signal in the recording/reproduction of an information recording medium inexpensively fabricated with multiple information recording surfaces. The optical pickup device includes: a laser diode that emits a light beam; a grating that splits the light beam into at least a main beam, a first sub beam, and a second sub beam; and an objective lens that condenses the light beams and forms at least three spots on an optical disc, wherein the spot of the first sub beam and the spot of the second sub beam are located inside or outside the spot of the main beam on the optical disc, and a tracking error signal is generated from signals obtained by detecting the first sub beam and the second sub beam.

### INCORPORATION BY REFERENCE

This application relates to and claims priority from Japanese Patent Application No. 2011-144327 filed on Jun. 29, 2011, the entire disclosure of which is incorporated herein by reference.

### BACKGROUND OF THE INVENTION

(1) Field of the Invention

The present invention relates to an optical pickup device, optical disc apparatus, and an information recording method.

(2) Description of the Related Art

A background art in the technical field is disclosed in, for example, Japanese Patent Application Laid-Open No. 2005-302085 (hereinafter, will be referred to as Patent Document 1) that describes a problem “the transfer of a tracking pattern to all the layers to form tracking for multilayer recording increases the manufacturing cost of a medium” and describes a solution “a server pattern is formed beforehand only on a part of a medium and one of two light spots is emitted to a servo pattern to perform tracking while the other light spot forms another servo pattern”.

### SUMMARY OF THE INVENTION

Optical discs such as a Blu-ray disc (BD) provided with at least two recording layers have increased in storage capacity. A storage capacity is expected to be increased by a larger number of disc layers. However, current multi layer discs have the following problems:

For example, a method of manufacturing a dual layer BD will be discussed below. First, pits and guide grooves are formed on one surface of a substrate made of materials such as a polycarbonate resin. After that, a metallic thin film, a thin-film material allowing thermal printing, and so on are formed on the molding resin substrate to form a Layer 0 and then an ultraviolet hardening resin is formed on the Layer 0. A resin stamper having pits and guide grooves is pressed to the ultraviolet hardening resin so as to transfer the pits and the guide grooves onto the ultraviolet hardening resin.

Then, the ultraviolet hardening resin is irradiated with ultraviolet rays through the resin stamper, so that the ultraviolet hardening resin is hardened by the ultraviolet rays. The resin stamper is then removed and a metallic thin film, a thin-film material allowing thermal printing, and so on are formed on the ultraviolet hardening resin to form a Layer 1. An ultraviolet hardening resin is then formed on the Layer 1 and a protective layer for a recording layer is formed on the recording layer of the Layer 1. The dual layer disc is fabricated thus. A multi layer disc can be fabricated by repeatedly forming the Layer 0 and the Layer 1.

A multi layer disc requires a complicated operation of pressing a resin stamper onto an ultraviolet hardening resin to form guide grooves. Moreover, recording layers all need to satisfy standards on, e.g., a disc pit shape, a guide groove shape, and a disc eccentricity, so that yields in a manufacturing line decrease with an increase in the number of recording layers. For this reason, disc recording layers with simple configurations have been demanded.

As described above, the manufacturing of a multi layer disc has the disadvantages of complicated operations and low yields. Thus, multi layer discs require high manufacturing cost.

To address this problem, in Patent Document 1, an optical disc is irradiated with a first light spot and a second light spot and a tracking control mark is formed by the second spot while tracking control is performed using the first light spot, which eliminates the need for forming guide grooves beforehand on all the layers of a multi layer disc, leading to lower medium manufacturing cost.

In the configuration of Patent Document 1, however, a tracking error signal cannot be stably generated during recording. Typical methods of detecting a tracking error signal from a beam as in Patent Document 1 include a push pull (PP) method and a differential phase detection (DPD) method. In the PP method, the interference region of light diffracted by guide grooves is detected by two equal detection parts. However, the disc of Patent Document 1 has no guide grooves and thus a PP signal is not generated. Furthermore, pits formed by irradiation of a light beam only lead to a small PP signal amplitude, so that a stable PP signal cannot be obtained.

The DPD method also has a disadvantage. The DPD method is a detection method using a phase difference of a mark. The phase difference occurs between at least detected signals from two equal detection parts when scanning on the mark on a disc is deviated from the center of the mark. Thus, in the DPD method, a tracking error signal is generated by comparing the high-frequency signals of recording marks.

In the case of recording, a laser blinks at high frequencies to form a recording mark/space. Hence, in the case where the first light spot and the second light spot are emitted from the same laser, the laser blinking at high frequencies during recording prevents high frequency signals such as a DPD signal from being simultaneously detected with stability. For example, in the case where the first and second light spots are emitted from different lasers, the lasers do not cause any problems but the configuration of an optical pickup device becomes inevitably complicated and expensive.

The present invention provides an optical pickup device, an optical disc apparatus including the same, and an information recording method which can obtain a stable servo signal in the recording/reproduction of an information recording medium inexpensively fabricated with multiple information recording surfaces.

The present invention has been made as set forth in the claims.

The present invention can provide an optical pickup device, an optical disc apparatus including the same, and an information recording method which can obtain a stable servo signal in the recording/reproduction of an information recording medium inexpensively fabricated with multiple information recording surfaces.

### BRIEF DESCRIPTION OF THE DRAWINGS

These and other features, objects and advantages of the present invention will become more apparent from the following description when taken in conjunction with the accompanying drawings wherein:

FIG. 1 is an explanatory drawing illustrating an optical system according to a first embodiment;

FIG. 2 illustrates a grating according to the first embodiment;

FIG. 3 shows the relationship between recording marks and spots on a disc according to the first embodiment;

FIG. 4 shows the relationship between a light beam and a detection part on a detector according to the first embodiment;

FIGS. 5A to 5C show the relationship between the recording marks and the spots on the disc according to the first embodiment;

FIG. 6 illustrates a recording method of an optical disc according to the first embodiment;

FIG. 7 shows the relationship between the recording marks and the spots on the disc according to the first embodiment;

FIG. 8 shows the relationship between the light beam and the detection part on the detector according to the first embodiment;

FIG. 9 shows the relationship between recording marks and spots on a disc according to a second embodiment;

FIG. 10 shows the relationship between a light beam and a detection part on a detector according to the second embodiment;

FIG. 11 shows the relationship between the recording marks and the spots on the disc according to the second embodiment;

FIG. 12 shows the relationship between the light beam and the detection part on the detector according to the second embodiment;

FIG. 13 illustrates another grating according to the second embodiment;

FIG. 14 shows the relationship between recording marks and spots on a disc according to a third embodiment;

FIG. 15 shows the relationship between a light beam and a detection part on a detector according to the third embodiment;

FIG. 16 is an explanatory drawing illustrating an optical system according to a fourth embodiment;

FIG. 17 shows the relationship between an optical disc and a light beam according to the fourth embodiment;

FIG. 18 is a flowchart showing the steps of an information recording method according to the fourth embodiment;

FIG. 19 is an explanatory drawing illustrating an optical reproducing apparatus according to a fifth embodiment; and

FIG. 20 is an explanatory drawing illustrating an optical recording/reproducing apparatus according to a sixth embodiment.

### DETAILED DESCRIPTION OF THE EMBODIMENT

Embodiments of the present invention will be described below with reference to the accompanying drawings.

### First Embodiment

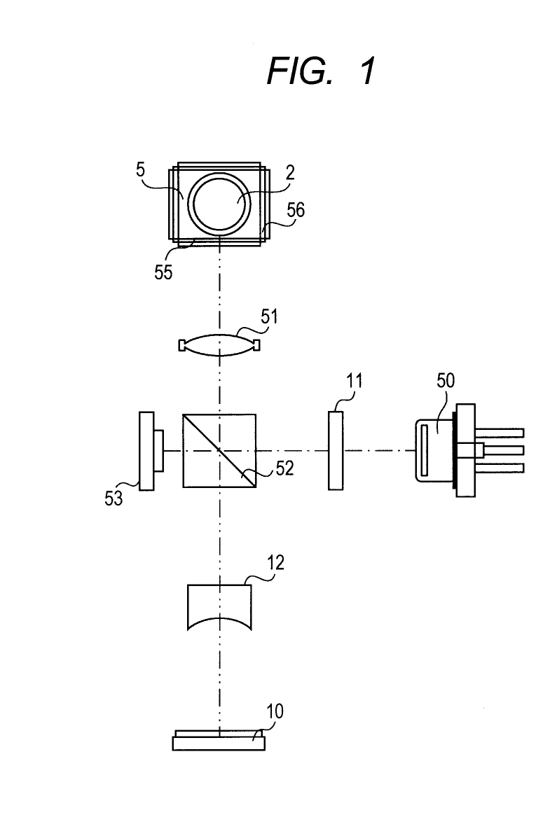

FIG. 1 illustrates the optical system of an optical pickup device according to a first embodiment of the present invention. A laser diode 50 emits a light beam having a wavelength of about 405 nm as a diverging ray. The light beam from the laser diode 50 is incident on a grating 11.

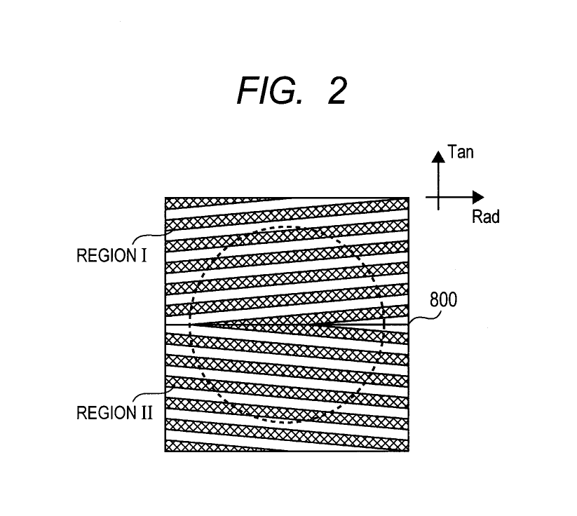

FIG. 2 illustrates the pattern of the grating 11. The grating 11 is divided into upper and lower regions I and II with respect to a disc tangential direction (Tan direction). The incident light beam is diffracted in different directions in the regions I and II. The diffraction efficiency of the grating 11 is expressed as, for example, zero-order diffracted light: +1^{st}-order diffracted light: −1^{st}-order diffracted light=10:0:1.

The light beam diffracted by the grating 11 is reflected on a beam splitter 52. The light beam partially passes through the beam splitter 52 and strikes a front monitor 53. Generally, in the case where information is recorded on a recordable-type optical disc, the recording surface of the optical disc is irradiated with a predetermined quantity of light. This requires precise control of the light quantity of the laser diode. Thus, when a signal is recorded on a recordable-type optical disc, the front monitor 53 detects a change of the light quantity of the laser diode 50 and feeds back the change to the drive circuit (not shown) of the laser diode 50, so that a quantity of light on the optical disc can be monitored and controlled to the predetermined light quantity.

The light beam reflected from the beam splitter 52 is incident on a collimating lens 51. The collimating lens 51 has a mechanism driven in the optical axial direction. The collimating lens 51 driven in the optical axial direction changes divergence and convergence of the light beam incident on an objective lens, thereby compensating for a spherical aberration caused by a thickness error of the cover layer of an optical disc 100. The light beam from the collimating lens 51 passes through a reflection mirror 55 and a quarter wave plate 56 and is focused onto the optical disc 100 through an objective lens 2 provided in an actuator 5. The focused light beam includes three light beams, that is, a main beam and two sub beams. In this case, the numerical aperture of the objective lens is 0.85 that is equal to that of a BD. The reflection mirror 55, the quarter wave plate 56, and the objective lens 2 overlapping one another in FIG. 1 are arranged in this order from the bottom to the top.

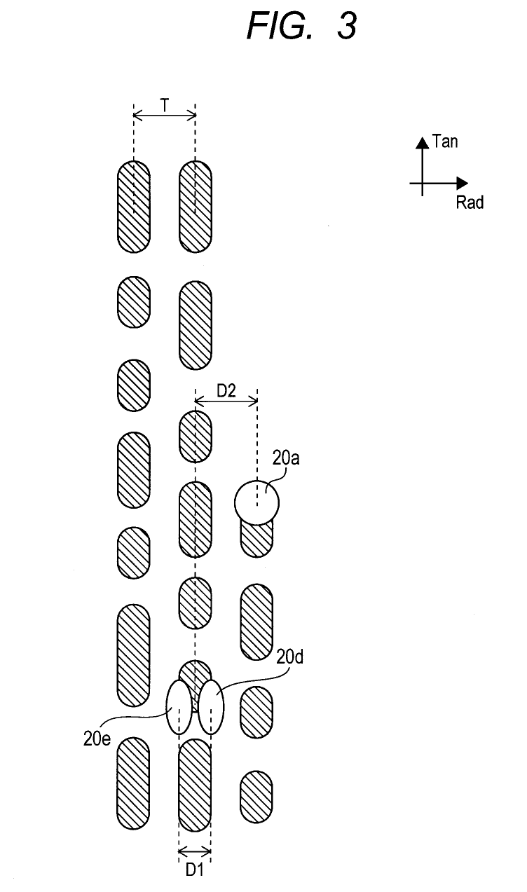

FIG. 3 shows the relationship between recording marks and spots on the disc. Zero-order diffracted light from the grating 11 forms a spot 20a (main beam), −1^{st}-order diffracted light from the region I forms a spot 20d (sub beam), and −1^{st}-order diffracted light from the region II forms a spot 20e (sub beam). A distance D1 between the spots 20d and 20e in the radial direction of the disc is expressed by (n+1/2) T (n is an integer not smaller than 0) where T is a distance between the recording marks in the radial direction of the disc (Rad direction). A distance D2 between the center of the spots 20d and 20e and the spot 20a in the radial direction of the disc is expressed by (m+1)T/2 (m is an integer not smaller than 0). Moreover, n=0 and m=1 are established in the present embodiment.

The light beam reflected on the optical disc 100 passes through the objective lens 2, the quarter wave plate 56, the reflection mirror 55, the collimating lens 51, the beam splitter 52, and a detecting lens 12 and strikes a detection part on a detector 10. Since astigmatism is provided through the detecting lens 12, a focusing error signal is detected by an astigmatic method.

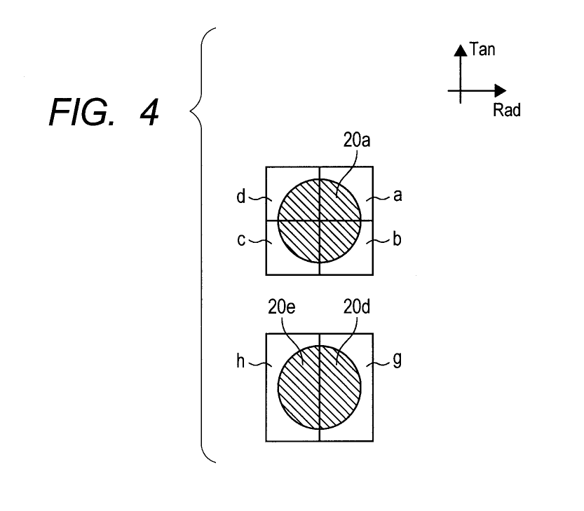

FIG. 4 shows the relationship between a light beam and the detection part on the detector 10. The same light beam as on the disc is indicated by the same reference character on the detector. The light beam in FIG. 4 is rotated by about 90° with respect to the grating 11 in FIG. 2 because of the astigmatic method.

The zero-order diffracted light 20a of the grating 11 is incident on quadrant regions a, b, c, and d of the detection part, and the −1^{st}-order diffracted light 20d and the −1^{st}-order diffracted light 20e are incident on two equal regions g and h of the detection part. Signals A, B, C, D, G, and H obtained from the regions a, b, c, d, g, and h are calculated to generate the focusing error signal (FES), the tracking error signal (TES), and an RF signal (RF) as below.

FES=(A+C)−(B+D)

TES=G−H

RF=A+B+C+D Numerical Formula 1

A method of generating the tracking error signal will be described below.

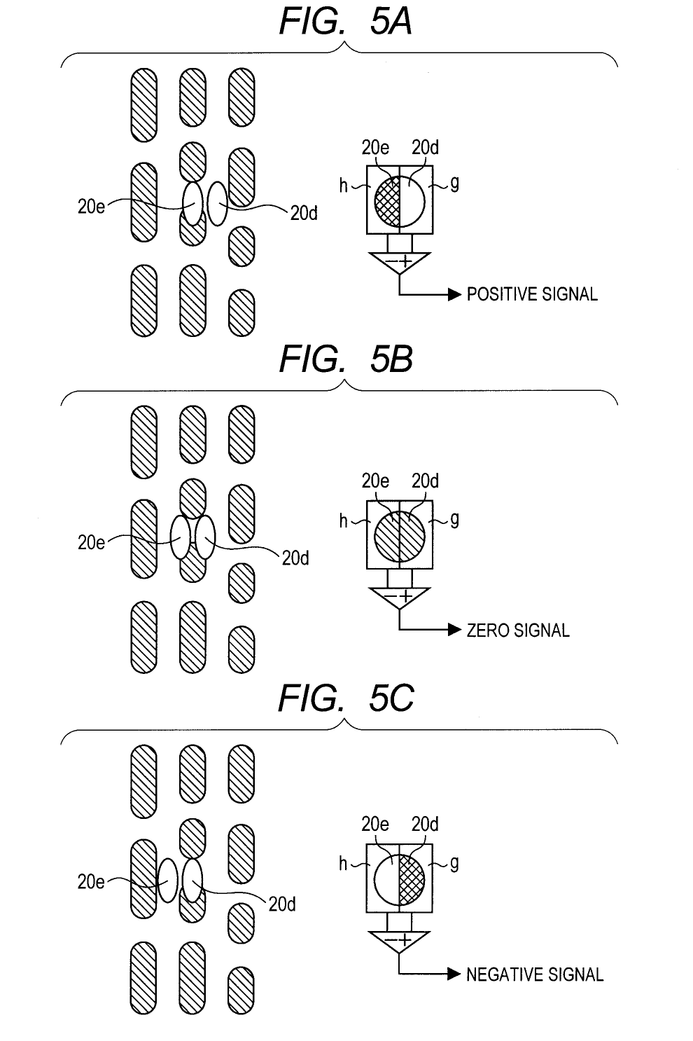

FIGS. 5A to 5C illustrate positional relationships between the recording marks and the spots 20d and 20e on the disc and signals in the relationships. FIGS. 5A to 5C illustrate different spot positions. FIG. 5A illustrates scanning of the spot 20e along the recording marks. FIG. 5C illustrates scanning of the spot 20d along the recording marks. FIG. 5B illustrates scanning of the center of the spot 20d and the spot 20e along the recording marks. In this case, the recording marks have a lower reflectivity than unrecorded portions.

First, in FIG. 5A, the spot 20e scanning along the recording marks causes the spot 20d to have a larger signal light quantity than the spot 20e, so that a positive signal is obtained by a tracking error signal operation. In FIG. 5C, the spot 20d scanning along the recording marks causes the spot 20e to have a larger signal light quantity than the spot 20d, so that a negative signal is obtained by a tracking error signal operation. In FIG. 5B, the spot 20d and the spot 20e are similarly offset from the center of the mark. This allows the spots 20d and 20e to have equal signal light quantities, so that a zero signal is obtained by a tracking error signal operation.

Hence, tracking control with a zero tracking error signal causes the center of the spots 20d and 20e to scan along the recording marks, allowing the spot 20a to continue recording. The tracking error signal can be generated when the distance D1 between the spots 20d and 20e in the radial direction of the disc satisfies (n+1/2) T (n is an integer not smaller than 0) where T is a distance between the recording marks in the radial direction. The generated tracking error signal is synchronized with the recording mark of the spot 20a when the distance D2 between the center of the spots 20d and 20e and the spot 20a in the radial direction of the disc satisfies (m+1)T/2 (m is an integer not smaller than 0).

In the tracking error signal detection method, high frequency signals do not need to be compared with each other unlike in the detection of a DPD signal and only a servo frequency band is necessary. Thus, a laser blinking at high frequencies does not affect detection during recording.

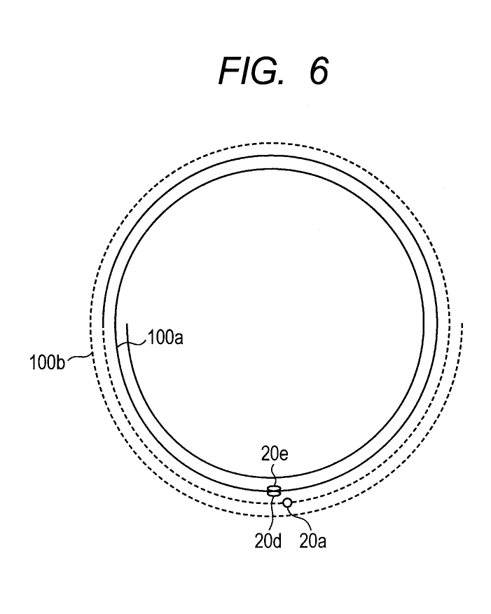

As described above, according to the present embodiment, the three spots are formed on the disc such that a distance between the spots of the two sub beams is expressed as (n+1/2)T and a distance between the center of the spots (spots 20d and 20e) of the two sub beams and the spot of the main beam (spot 20a) is expressed as (m+1) T/2 where T is a distance between the recording marks in the radial direction and n and m are integers not smaller than 0. This allows detection of a stable tracking error signal. Thus, as illustrated in FIG. 6, the recording marks formed beforehand partially on the inner edge or the outer edge of the disc enable recording along the recording marks.

FIG. 6 illustrates a method of recording from the inner edge to the outer edge. For example, the recording direction can be reversed by changing a disc spiral structure and the position of the spot 20a relative to the spot 20d and the spot 20e. A solid line indicates recording marks after recording and a dotted line indicates recording marks during recording according to the present embodiment.

In the present embodiment, the main beam and the at least two sub beams are emitted. The two sub beams are located inside or outside the main beam on the disc. The center of the two sub beams is separated from the main beam in the radial direction at least by a half the distance between the recording marks in the radial direction. The tracking error signal can be detected by determining a difference between the two sub beams. Since the pickup device performs recording while exercising tracking control on the recording marks, started recording can be continued as long as unrecorded radial positions are found on the disc.

An information recording method using the optical pickup device according to the present embodiment can simplify the structure of the optical disc, thereby considerably reducing the cost of a multi layer disc.

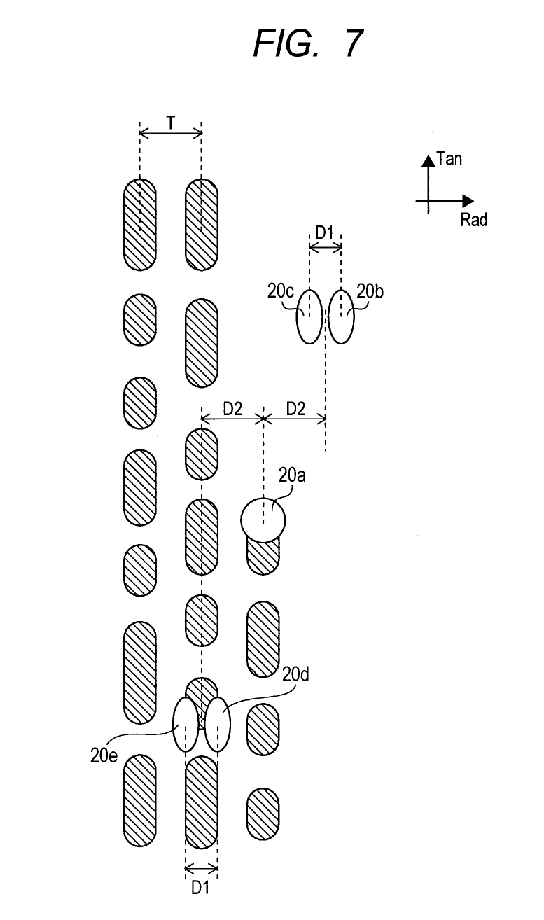

For example, the recording marks may be recorded beforehand on the disc upon the shipment of the disc. Since the three spots are used in the present embodiment, recording can be performed only in one direction, e.g., from the inner edge to the outer edge or from the outer edge to the inner edge. For example, the diffraction efficiency of the grating 11 is expressed as zero-order diffracted light: +1^{st}-order diffracted light: −1^{st}-order diffracted light=10:1:1 and five beams are located on the disc as illustrated in FIG. 7, which enables recording in both directions. The zero-order diffracted light from the grating 11 forms the spot 20a (main beam), +1^{st}-order diffracted light from the region I forms the spot 20b (sub beam), the −1^{st}-order diffracted light from the region I forms the spot 20d (sub beam), positive diffracted light from the region II forms the spot 20c (sub beam), and the −1^{st}-order diffracted light from the region II forms the spot 20e (sub beam). The distance D1 between the spot 20b and the spot 20c (spots 20d and 20e) in the radial direction of the disc is expressed by (n+1/2)T (n is an integer not smaller than 0) where T is a distance between the recording marks in the radial direction. The distance D2 between the center of the spots 20b and 20c (the spot 20a and the center of the spots 20d and 20e) and the spot 20a in the radial direction of the disc is expressed by (m+1)T/2 (m is an integer not smaller than 0).

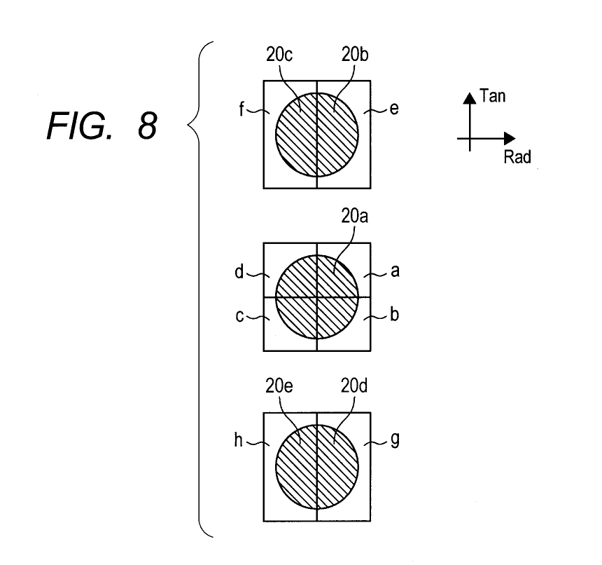

A signal may be detected using the detection part illustrated in FIG. 8. The zero-order diffracted light 20a from the grating 11 is incident on the quadrant regions a, b, c, and d of the detection part, the +1^{st}-order diffracted light 20b and the +1^{st}-order diffracted light 20c are incident on two equal regions e and f of the detection part, and the −1^{st}-order diffracted light 20d and the −1^{st}-order diffracted light 20e are incident on the two equal regions g and h of the detection part. Signals A, B, C, D, E, F, G, and H obtained from the regions a, b, c, d, e, f, g, and h are calculated to generate the focusing error signal, the tracking error signal, and the RF signal as below.

FES=(A+C)−(B+D)

TES=G−H

RF=A+B+C+D Numerical Formula 1

In this case, recording from the inner edge to the outer edge is shown. For example, recording from the outer edge to the inner edge requires the following operations:

FES=(A+C)−(B+D)

TES=E−F

RF=A+B+C+D Numerical Formula 2

The above operations can respond to recording in both directions. In the present embodiment, the collimating lens 51 is driven in the optical axial direction in the spherical aberration correction but the method of spherical aberration correction is not limited. For example, a beam expander may be incorporated into the optical system. Moreover, in the present embodiment, the focusing error signal is detected by the astigmatic method but the method of detecting the focusing error signal is not limited to the astigmatic method. The detection method may be combined with a focusing error signal detection method, e.g., a knife-edge method and a spot-size method. Furthermore, the wavelength of the laser diode and the numerical aperture of the objective lens are not limited to those of the present embodiment.

The grating according to the first embodiment of the present invention is not limited to the grating in FIG. 2. The same effect can be obtained by arranging three or five beams on the disc with the spot distances D1 and D2.

Furthermore, tracking control according to the present embodiment is not limited to tracking control along inner recording marks. Tracking control may be performed along further inner recording marks as long as the corresponding recording marks have been recorded on the disc. In this case, m may be changed.

Recording may be performed from the inner edge to the outer edge or from the outer edge to the inner edge. In the case where the tracking error signal during recording from the inner edge to the outer edge and the tracking error signal during recording from the outer edge to the inner edge are generated by different operations, the signals may be received from an optical disc apparatus depending upon the recording direction and the signal output may be changed by the optical pickup device. In order to reduce the number of signal outputs, for example, the regions g and e may be combined and the regions f and h may be combined in the detection part of FIG. 8 to output the signals. The present embodiment described the method of detecting the tracking error signal during recording. In the case of reproduction, the detection method of the present embodiment may be used or tracking control may be performed using the main beam with a DPD signal.

### Second Embodiment

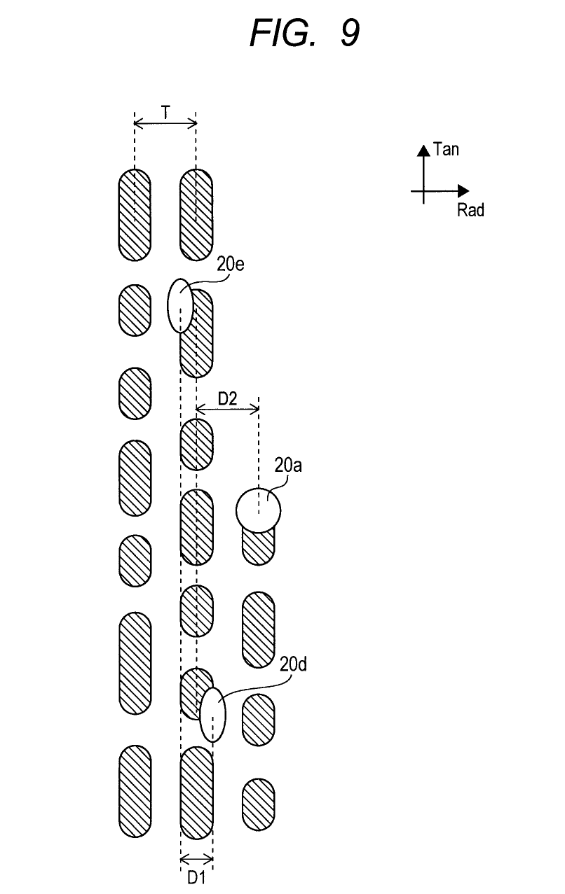

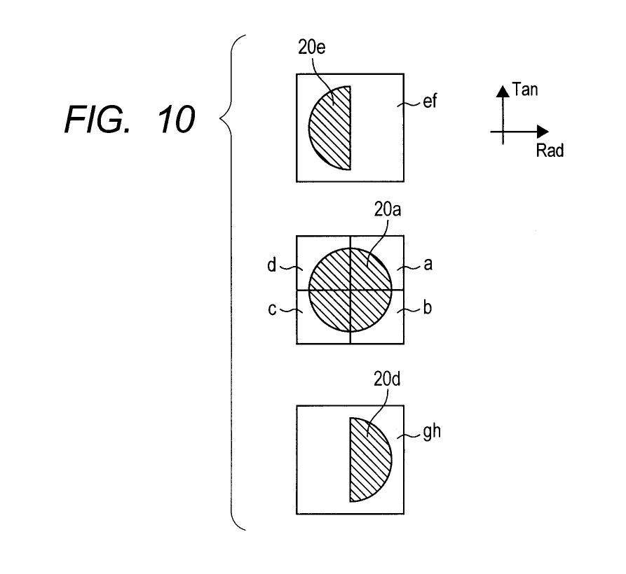

FIGS. 9 and 10 illustrate the relationship between the recording marks of an optical pickup device and spots on a disc and the relationship between a light beam and a detection part on a detector according to a second embodiment of the present invention. Other configurations are identical to those of the first embodiment.

An optical system in the present embodiment is identical to that of the first embodiment in FIG. 1. A laser diode 50 emits a light beam having a wavelength of about 405 nm as a diverging ray. The light beam from the laser diode 50 is incident on a grating 11. FIG. 2 illustrates the pattern of the grating 11. The grating 11 is divided into upper and lower regions I and II with respect to the tangential direction of the disc. The incident light beam is diffracted in different directions in the regions I and II. The diffraction efficiency of the grating 11 is expressed as, for example, zero-order diffracted light: +1^{st}-order diffracted light: −1^{st}-order diffracted light=10:0:1.

The light beam diffracted by the grating 11 is reflected on a beam splitter 52. The light beam partially passes through the beam splitter 52 and strikes a front monitor 53.

The light beam reflected from the beam splitter 52 is incident on a collimating lens 51. The collimating lens 51 has a mechanism driven in the optical axial direction. The collimating lens 51 driven in the optical axial direction changes the divergence and convergence of the light beam incident on an objective lens, thereby compensating for a spherical aberration caused by a thickness error of the cover layer of an optical disc 100. The light beam from the collimating lens 51 passes through a reflection mirror 55 and a quarter wave plate 56 and is focused onto the optical disc 100 through an objective lens 2 provided in an actuator 5. The focused light beam includes three light beams, that is, a main beam and two sub beams. In this case, the numerical aperture of the objective lens is 0.85 that is equal to that of a BD. The reflection mirror 55, the quarter wave plate 56, and the objective lens 2 overlapping one another in FIG. 1 are arranged in this order from the bottom to the top.

FIG. 9 shows the relationship between the recording marks and the spots on the disc. Zero-order diffracted light from the grating 11 forms a spot 20a (main beam), −1^{st}-order diffracted light from the region I forms a spot 20d (sub beam), and −1^{st}-order diffracted light from the region II forms a spot 20e (sub beam). A distance D1 between the spots 20d and 20e in the radial direction of the disc is expressed by (n+1/2)T (n is an integer not smaller than 0) where T is a distance between the recording marks in the radial direction of the disc. A distance D2 between the center of the spots 20d and 20e and the spot 20a in the radial direction of the disc is expressed by (m+1)T/2 (m is an integer not smaller than 0). Moreover, n=0 and m=1 are established in the present embodiment.

The light beam reflected on the optical disc 100 passes through the objective lens 2, the quarter wave plate 56, the reflection mirror 55, the collimating lens 51, the beam splitter 52, and a detecting lens 12 and strikes a detection part on a detector. Since astigmatism is provided through the detecting lens 12, a focusing error signal is detected by an astigmatic method.

FIG. 10 shows the relationship between a light beam and the detection part on the detector 10. The same light beam as on the disc is indicated by the same reference character on the detector 10. The light beam in FIG. 10 is rotated by about 90° with respect to the grating 11 in FIG. 2 because of the astigmatic method.

The zero-order diffracted light 20a of the grating 11 is incident on quadrant regions a, b, c, and d of the detection part, the −1^{st}-order diffracted light 20d of the region I is incident on a detection part gh, and the −1^{st}-order diffracted light 20e of the region II is incident on a half detection part ef. Signals A, B, C, D, EF, and GH obtained from the regions a, b, c, d, ef, and gh are calculated to generate the focusing error signal, a tracking error signal, and an RF signal as below.

FES=(A+C)−(B+D)

TES=GH−EF

RF=A+B+C+D Numerical Formula 3

A method of detecting the tracking error signal according to the present embodiment is similar to that of the first embodiment. The present embodiment is different from the first embodiment only in the position of the spot 20e on the disc in the tangent direction of the disc. The tracking error signal can be generated when the distance D1 between the spots 20d and 20e in the radial direction of the disc satisfies (n+1/2)T (n is an integer not smaller than 0) where T is a distance between the recording marks in the radial direction. The generated tracking error signal is synchronized with the recording mark of the spot 20a when the distance D2 between the center of the spots 20d and 20e and the spot 20a in the radial direction of the disc satisfies (m+1) T/2 (m is an integer not smaller than 0).

In the tracking error signal detection method, high frequency signals do not need to be compared with each other unlike in the detection of a DPD signal and only a servo frequency band is necessary. Thus, a laser blinking at high frequencies does not affect detection during recording.

As described above, according to the present embodiment, the three spots are formed on the disc such that a distance between the spots of the two sub beams is expressed as (n+1/2) T and a distance between the center of the spots (spots 20d and 20e) of the two sub beams and the spot of the main beam (spot 20a) is expressed as (m+1)T/2 where T is a distance between the recording marks in the radial direction and n and m are integers not smaller than 0. This allows detection of a stable tracking error signal. Thus, as illustrated in FIG. 6, the recording marks formed beforehand partially on the inner edge or the outer edge of the disc enable recording along the recording marks. FIG. 6 illustrates a method of recording from the inner edge to the outer edge. For example, the recording direction can be reversed by changing a disc spiral structure and the position of the spot 20a relative to the spot 20d and the spot 20e. A solid line indicates recording marks after recording and a dotted line indicates recording marks during recording according to the present embodiment.

In the present embodiment, the main beam and the at least two sub beams are emitted. The two sub beams are located inside or outside the main beam on the disc. The center of the two sub beams is separated from the main beam in the radial direction at least by a half the distance between the recording marks in the radial direction. The tracking error signal can be detected by determining a difference between the two sub beams. Since the pickup device performs recording while exercising tracking control on the recording marks, started recording can be continued as long as unrecorded radial positions are found on the disc.

An information recording method using the optical pickup device according to the present embodiment can simplify the structure of the optical disc, thereby considerably reducing the cost of a multi layer disc.

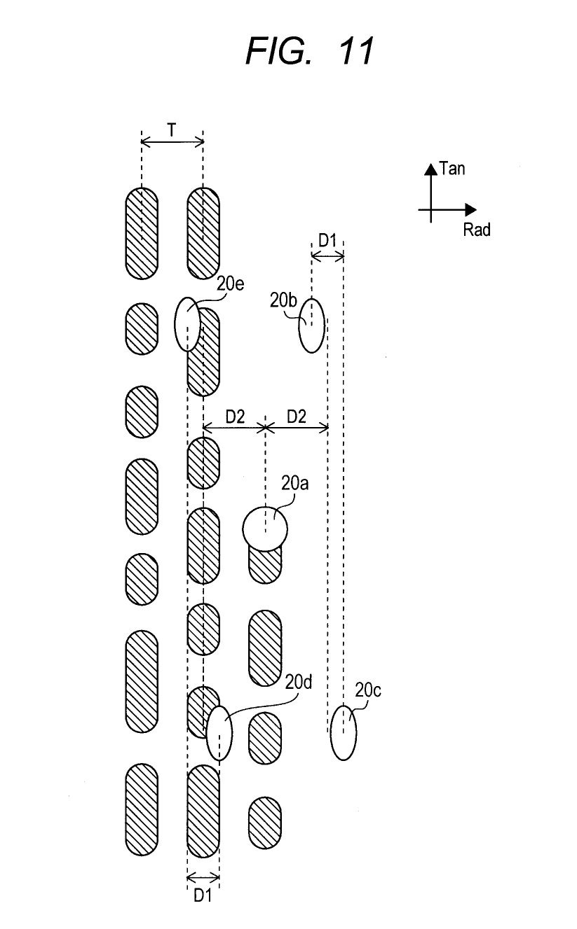

For example, the recording marks may be recorded beforehand on the disc upon the shipment of the disc. Since the three spots are used in the present embodiment, recording can be performed only in one direction, e.g., from the inner edge to the outer edge or from the outer edge to the inner edge. For example, the diffraction efficiency of the grating 11 is expressed as zero-order diffracted light: +1^{st}-order diffracted light: −1^{st}-order diffracted light=10:1:1 and five beams are located on the disc as illustrated in FIG. 11, which enables recording in both directions. The zero-order diffracted light from the grating 11 forms the spot 20a (main beam), +1^{st}-order diffracted light from the region I forms the spot 20b (sub beam), the −1^{st}-order diffracted light from the region I forms the spot 20d (sub beam), positive diffracted light from the region II forms the spot 20c (sub beam), and the −1^{st}-order diffracted light from the region II forms the spot 20e (sub beam). The distance D1 between the spot 20b and the spot 20c (spots 20d and 20e) in the radial direction of the disc is expressed by (n+1/2)T (n is an integer not smaller than 0) where T is a distance between the recording marks in the radial direction.

The distance D2 between the center of the spots 20b and 20c (the spot 20a and the center of the spots 20d and 20e) and the spot 20a in the radial direction of the disc is expressed by (m+1)T/2 (m is an integer not smaller than 0).

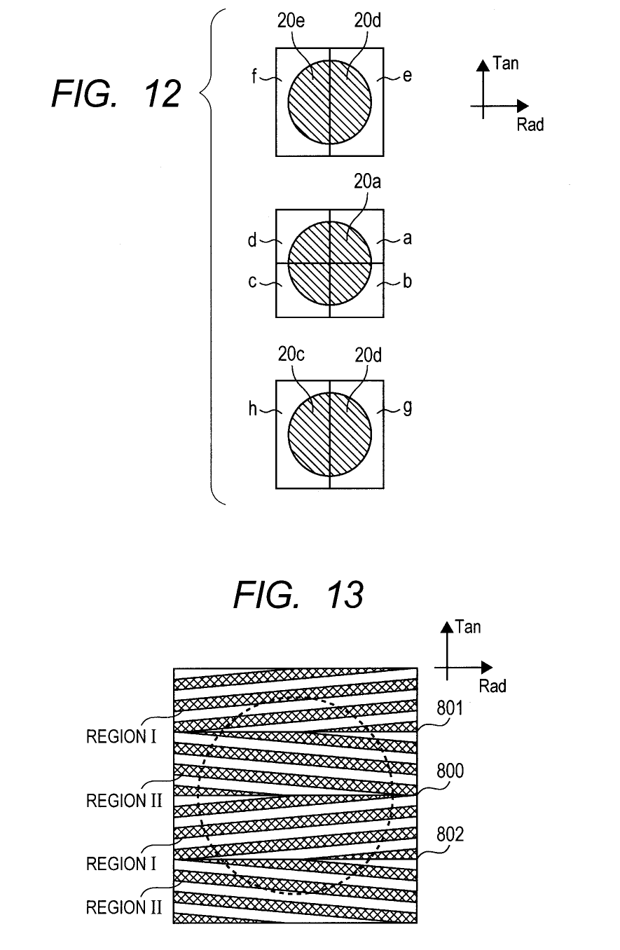

A signal may be detected using the detection part illustrated in FIG. 12. The zero-order diffracted light 20a from the grating 11 is incident on the quadrant regions a, b, c, and d of the detection part, the +1^{st}-order diffracted light 20b from the region I and the −1^{st}-order diffracted light 20e from the region II are incident on two equal regions e and f of the detection part, and the −1^{st}-order diffracted light 20d from the region I and the +1^{st}-order diffracted light 20c from the region II are incident on two equal regions g and h of the detection part. Signals A, B, C, D, E, F, G, and H obtained from the regions a, b, c, d, e, f, g, and h are calculated to generate the focusing error signal, the tracking error signal, and the RF signal as below.

FES=(A+C)−(B+D)

TES=G−F

RF=A+B+C+D Numerical Formula 4

In this case, recording from the inner edge to the outer edge is shown. For example, recording from the outer edge to the inner edge requires the following operations:

FES=(A+C)−(B+D)

TES=E−H

RF=A+B+C+D Numerical Formula 5

The above operations can respond to recording in both directions.

The collimating lens 51 is driven in the optical axial direction in spherical aberration correction but the method of spherical aberration correction is not limited in the present embodiment. For example, a beam expander may be incorporated into the optical system. Moreover, in the present embodiment, the focusing error signal is detected by the astigmatic method but the method of detecting the focusing error signal is not limited to the astigmatic method. The detection method may be combined with a focusing error signal detection method, e.g., a knife-edge method and a spot-size method. Furthermore, the wavelength of the laser diode and the numerical aperture of the objective lens are not limited to those of the present embodiment.

The grating according to the second embodiment of the present invention is not limited to the grating in FIG. 2. The same effect can be obtained by arranging three or five beams on the disc with the spot distances D1 and D2. For example, the same effect can be obtained by dividing a groove structure (regions I and II) in FIG. 2 into multiple regions as illustrated in FIG. 13 and detecting signals by means of the same detector as in FIG. 10 while arranging the spots on the disc as illustrated in FIG. 9. In this case, the diffraction efficiency of the grating 11 is expressed as, for example, zero-order diffracted light: +1^{st}-order diffracted light: −1^{st}-order diffracted light=10:0:1.

Furthermore, tracking control according to the present embodiment is not limited to tracking control along inner recording marks. Tracking control may be performed along further inner recording marks as long as the corresponding recording marks have been recorded on the disc. In this case, m may be changed.

Recording may be performed from the inner edge to the outer edge or from the outer edge to the inner edge. In the case where the tracking error signal during recording from the inner edge to the outer edge and the tracking error signal during recording from the outer edge to the inner edge are generated by different operations, the signals may be received from an optical disc apparatus depending upon the recording direction and the signal output may be changed by the optical pickup device. In order to reduce the number of signal outputs, for example, the regions g and e may be combined and the regions f and h may be combined in the detection part of FIG. 12 to output signals.

The present embodiment described the method of detecting the tracking error signal during recording. In the case of reproduction, the detection method of the present embodiment may be used or tracking control may be performed using the main beam with a DPD signal.

### Third Embodiment

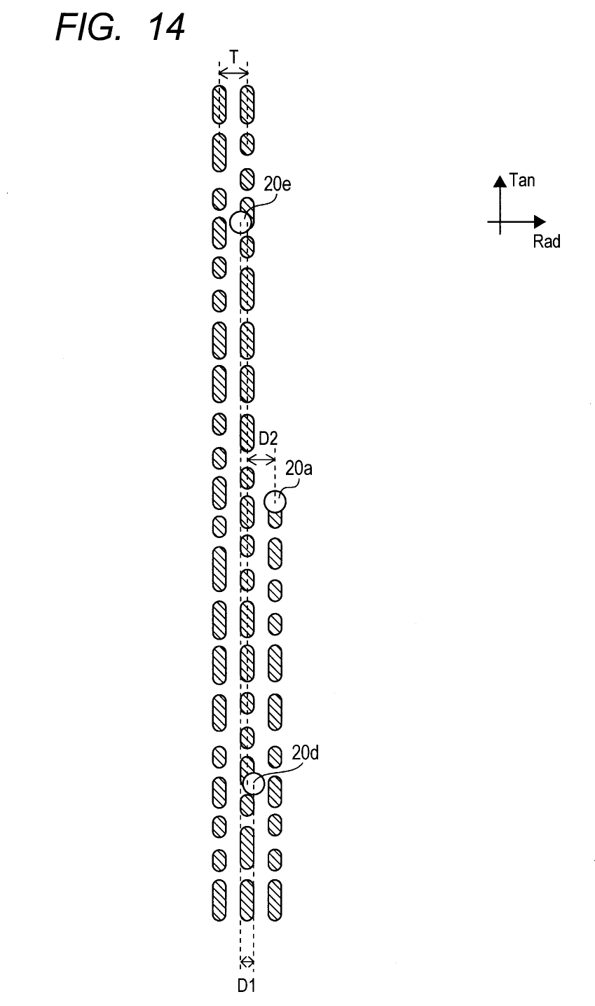

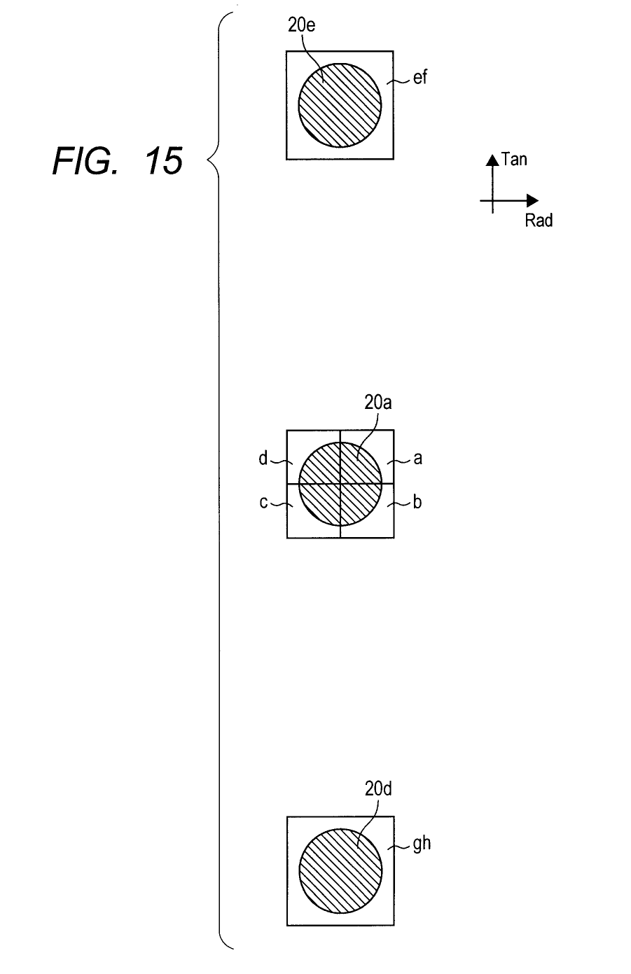

FIGS. 14 and 15 illustrate the relationship between the recording marks of an optical pickup device and spots on a disc and the relationship between a light beam and a detection part on a detector according to a third embodiment of the present invention. Other configurations are identical to those of the first embodiment.

An optical system in the present embodiment is identical to that of the first embodiment in FIG. 1. A laser diode 50 emits a light beam having a wavelength of about 405 nm as a diverging ray. The light beam from the laser diode 50 is incident on a grating 11. FIG. 2 illustrates the pattern of the grating 11. The grating 11 is divided into upper and lower regions I and II with respect to the tangential direction of the disc. The incident light beam is diffracted in different directions in the regions I and II. The diffraction efficiency of the grating 11 is expressed as, for example, zero-order diffracted light: +1^{st}-order diffracted light: −1^{st}-order diffracted light=10:0:1. The present embodiment is different from the second embodiment in that the grating 11 has a large diffraction angle.

The light beam diffracted by the grating 11 is reflected on a beam splitter 52. The light beam partially passes through the beam splitter 52 and strikes a front monitor 53.

The light beam reflected from the beam splitter 52 is incident on a collimating lens 51. The collimating lens 51 has a mechanism driven in the optical axial direction. The collimating lens 51 driven in the optical axial direction changes the divergence and convergence of the light beam incident on an objective lens, thereby compensating for a spherical aberration caused by a thickness error of the cover layer of an optical disc 100. The light beam from the collimating lens 51 passes through a reflection mirror 55 and a quarter wave plate 56 and is focused onto the optical disc 100 through an objective lens 2 provided in an actuator 5. The focused light beam includes three light beams, that is, a main beam and two sub beams. In this case, the numerical aperture of the objective lens is 0.85 that is equal to that of a BD. The reflection mirror 55, the quarter wave plate 56, and the objective lens 2 overlapping one another in FIG. 1 are arranged in this order from the bottom to the top.

Since the grating 11 has a large diffraction angle in the present embodiment, light passing through a partition 800 of the grating 11 is not incident on the objective lens. Thus, as to the light beam diffracted to the positive side in the tangential direction of the disc out of the light beam incident on the objective lens, the light beam diffracted in the region I, which is a positive-side region in the tangential direction of the disc, is not incident on the objective lens due to the diffraction, allowing only the light beam diffracted in the region II to be incident on the objective lens. Similarly, as to the light beam diffracted to the negative side in the tangential direction of the disc, the light beam diffracted in the region II, which is a negative-side region in the tangential direction of the disc, is not incident on the objective lens due to the diffraction, allowing only the light beam diffracted in the region I to be incident on the objective lens.

FIG. 14 shows the relationship between the recording marks and the spots on the disc. Zero-order diffracted light from the grating 11 forms a spot 20a (main beam), −1^{st}-order diffracted light from the region I forms a spot 20d (sub beam), and −1^{st}-order diffracted light from the region II forms a spot 20e (sub beam). A distance D1 between the spots 20d and 20e in the radial direction of the disc is expressed by (n+1/2)T (n is an integer not smaller than 0) where T is a distance between the recording marks in the radial direction. A distance D2 between the center of the spots 20d and 20e and the spot 20a in the radial direction of the disc is expressed by (m+1)T/2 (m is an integer not smaller than 0). Moreover, n=0 and m=1 are established in the present embodiment.

The light beam reflected on the optical disc 100 passes through the objective lens 2, the quarter wave plate 56, the reflection mirror 55, the collimating lens 51, the beam splitter 52, and a detecting lens 12 and strikes a detection part on a detector. Since astigmatism is provided through the detecting lens 12, a focusing error signal is detected by an astigmatic method.

FIG. 15 shows the relationship between a light beam and the detection part on a detector 10. The same light beam as on the disc is indicated by the same reference character on the detector 10. The light beam in FIG. 15 is rotated by about 90° with respect to the grating 11 in FIG. 2 because of the astigmatic method.

The zero-order diffracted light 20a of the grating 11 is incident on quadrant regions a, b, c, and d of the detection part, the −1^{st}-order diffracted light 20d of the region I is incident on a detection part gh, and the −1^{st}-order diffracted light 20e of the region II is incident on a half detection part ef. Signals A, B, C, D, EF, and GH obtained from the regions a, b, c, d, ef, and gh are calculated to generate the focusing error signal, the tracking error signal, and an RF signal as below.

FES=(A+C)−(B+D)

TES=GH−EF

RF=A+B+C+D Numerical Formula 3

A method of detecting the tracking error signal in the present embodiment is similar to that of the first embodiment. The present embodiment is different from the second embodiment only in the light quantities of the spots 20d and 20e on the detector 10. The tracking error signal can be generated when the distance D1 between the spots 20d and 20e in the radial direction of the disc satisfies (n+1/2)T (n is an integer not smaller than 0) where T is a distance between the recording marks in the radial direction. The generated tracking error signal is synchronized with the recording mark of the spot 20a when the distance D2 between the center of the spots 20d and 20e and the spot 20a in the radial direction of the disc satisfies (m+1)T/2 (m is an integer not smaller than 0).

In the tracking error signal detection method, high frequency signals do not need to be compared with each other unlike in the detection of a DPD signal and only a servo frequency band is necessary. Thus, a laser blinking at high frequencies does not affect detection during recording.

As described above, according to the present embodiment, the three spots are formed on the disc such that a distance between the spots of the two sub beams is expressed as (n+1/2)T and a distance between the center of the spots (spots 20d and 20e) of the two sub beams and the spot of the main beam (spot 20a) is expressed as (m+1) T/2 where T is a distance between the recording marks in the radial direction and n and m are integers not smaller than 0. This allows detection of a stable tracking error signal. Thus, as illustrated in FIG. 6, the recording marks formed beforehand partially on the inner edge or the outer edge of the disc enable recording along the recording marks. FIG. 6 illustrates a method of recording from the inner edge to the outer edge. For example, the recording direction can be reversed by changing a disc spiral structure and the position of the spot 20a relative to the spot 20d and the spot 20e. A solid line indicates recording marks after recording and a dotted line indicates recording marks during recording according to the present embodiment.

In the present embodiment, the main beam and the at least two sub beams are emitted. The two sub beams are located inside or outside the main beam on the disc. The center of the two sub beams is separated from the main beam in the radial direction at least by a half the distance between the recording marks in the radial direction. The tracking error signal can be detected by determining a difference between the two sub beams. Since the pickup device performs recording while exercising tracking control on the recording marks, started recording can be continued as long as unrecorded radial positions are found on the disc.

An information recording method using the optical pickup device according to the present embodiment can simplify the structure of the optical disc, thereby considerably reducing the cost of a multi layer disc.

For example, the recording marks may be recorded beforehand on the disc upon the shipment of the disc. The collimating lens 51 is driven in the optical axial direction in the spherical aberration correction but the method of spherical aberration correction is not limited in the present embodiment. For example, a beam expander may be incorporated into the optical system. Moreover, in the present embodiment, the focusing error signal is detected by the astigmatic method but the method of detecting the focusing error signal is not limited to the astigmatic method. The detection method may be combined with a focusing error signal detection method, e.g., a knife-edge method and a spot-size method. Furthermore, the wavelength of the laser diode and the numerical aperture of the objective lens are not limited to those of the present embodiment.

The grating according to the third embodiment of the present invention is not limited to the grating in FIG. 2. The same effect can be obtained by arranging three or five beams on the disc with the spot distances D1 and D2.

Furthermore, tracking control according to the present embodiment is not limited to tracking control along inner recording marks. Tracking control may be performed along further inner recording marks as long as the corresponding recording marks have been recorded on the disc. In this case, m may be changed. Recording may be performed from the inner edge to the outer edge or from the outer edge to the inner edge.

The configuration of the present embodiment can eliminate the influence of a deviation of the grating 11 in the tangential direction of the disc unlike in the first and second embodiments. The detection part of and the detection part gh are disposed outside stray light from the spot 20a on the multi layer disc, thereby reducing the influence of the stray light of the multi layer disc. The present embodiment described the method of detecting the tracking error signal during recording. In the case of reproduction, the detection method of the present embodiment may be used or tracking control may be performed using the main beam with a DPD signal.

### Fourth Embodiment

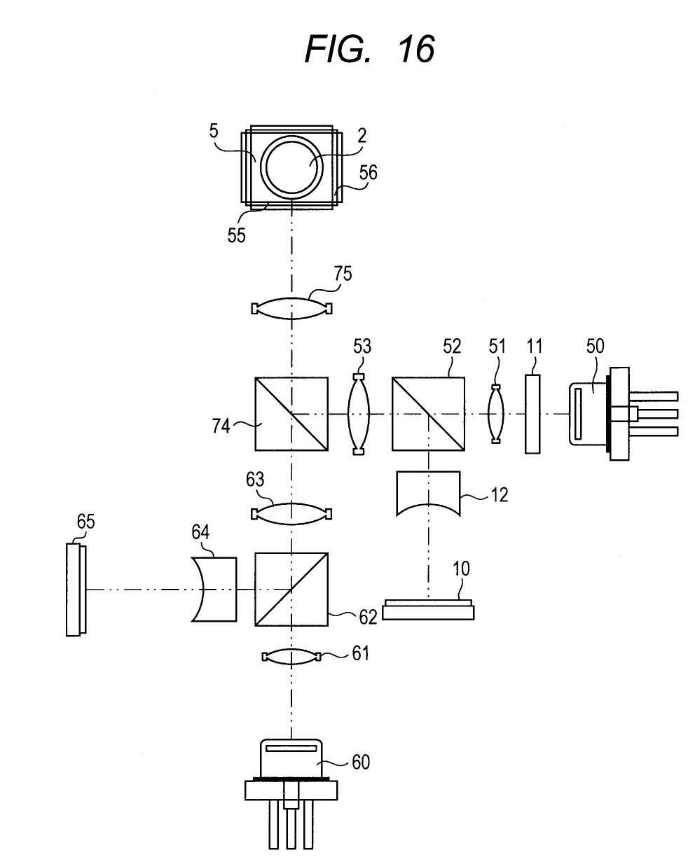

FIG. 16 illustrates an optical system of an optical pickup device according to a fourth embodiment of the present invention. An optical disc according to the present embodiment includes a layer for detecting a servo signal (guide layer) and a recording layer. A servo light beam and a light beam for recording/reproduction are emitted from an optical pickup.

The optical system for detecting a signal of the recording layer will be first described below. A laser diode 50 emits a light beam having a wavelength of about 405 nm as a diverging ray. The light beam from the laser diode 50 is incident on a grating 11. FIG. 2 illustrates the pattern of the grating 11. The grating 11 is divided into upper and lower regions I and II with respect to the tangential direction of the disc. The incident light beam is diffracted in different directions in the regions I and II. The diffraction efficiency of the grating 11 is expressed as, for example, zero-order diffracted light: +1^{st}-order diffracted light: −1^{st}-order diffracted light=10:0:1.

A first light beam diffracted through the grating 11 is transformed substantially into a parallel ray by a collimating lens 51. The light beam having passed through the collimating lens 51 strikes a reflection mirror 55 through a beam splitter 52, a lens 53, a dichroic prism 74, and a lens 75. The beam splitter 52 is a prism that exhibits polarizing characteristics to transmission and reflectivity. The beam splitter 52 efficiently transmits the light beam outgoing from the laser diode 50 and efficiently reflects the light beam reflected from the disc. The dichroic prism 74 has wavelength selectivity. In the present embodiment, the dichroic prism 74 reflects the first light beam outgoing from the laser diode 50 and transmits a second light beam outgoing from a laser diode 60.

In this configuration, the lens 53 can be driven in an optical axial direction. The lens 53 combined with the lens 75 can change divergence and convergence of the light beam incident on an objective lens, thereby correcting a spherical aberration caused by a difference between recording layers (substrate thickness) from the surface of the disc including the recording layers.

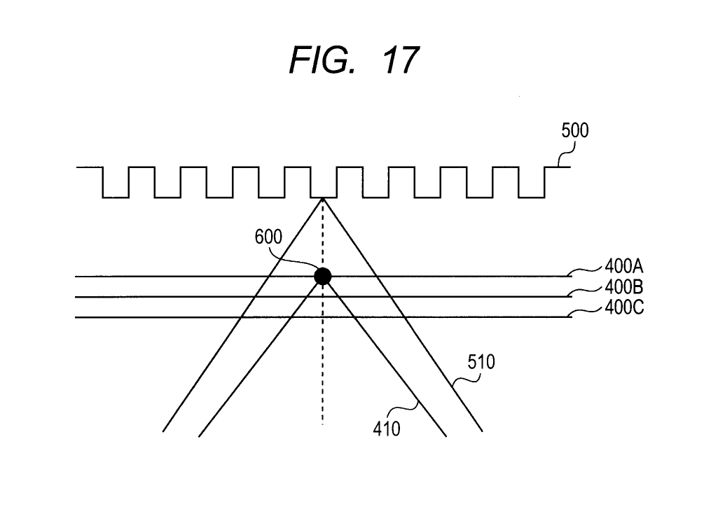

The light beam reflected from the reflection mirror 55 passes through the quarter wave plate 56 and is focused onto a recording layer 400A illustrated in FIG. 17 through an objective lens 2 provided in an actuator 5. The focused light beam includes three light beams, that is, a main beam and two sub beams. The recording layer 400A, a recording layer 400B, and a recording layer 400C in FIG. 17 have no guide grooves while a guide layer 500 has guide grooves.

FIG. 3 shows the relationship between recording marks and spots on the disc. Zero-order diffracted light from the grating 11 forms a spot 20a (main beam), −1^{st}-order diffracted light from a region I forms a spot 20d (sub beam), and −1^{st}-order diffracted light from a region II forms a spot 20e (sub beam). A distance D1 between the spots 20d and 20e in the radial direction of the disc is expressed by (n+1/2) T (n is an integer not smaller than 0) where T is a distance between the recording marks in the radial direction. A distance D2 between the center of the spots 20d and 20e and the spot 20a in the radial direction of the disc is expressed by (m+1) T/2 (m is an integer not smaller than 0). Moreover, n=0 and m=1 are established in the present embodiment.

The light beam reflected from the recording layer passes through the objective lens 2, a quarter wave plate 56, the reflection mirror 55, the lens 75, the dichroic prism 74, the lens 53, the beam splitter 52, and a detecting lens 12 and strikes a detection part on a detector 10. Since astigmatism is provided through the detecting lens 12, a focusing error signal is detected by an astigmatic method.

FIG. 4 shows the relationship between a light beam and the detection part on the detector 10. The same light beam as on the disc is indicated by the same reference character on the detector 10. The light beam in FIG. 4 is rotated by about 90° with respect to the grating 11 in FIG. 2 because of the astigmatic method.

The zero-order diffracted light 20a of the grating 11 is incident on quadrant regions a, b, c, and d of the detection part, and the −1^{st}-order diffracted light 20d and the −1^{st}-order diffracted light 20e are incident on two equal regions g and h of the detection part. Signals A, B, C, D, G, and H obtained from the regions a, b, c, d, g, and h are calculated to generate the focusing error signal, a tracking error signal, and an RF signal as below.

FES=(A+C)−(B+D)

TES=G−H

RF=A+B+C+D Numerical Formula 1

The optical system for detecting a signal of the guide layer will be described below. The second light beam having a wavelength of about 650 nm from the laser diode 60 is transformed substantially into a parallel ray by a collimating lens 61. The light beam having passed through the collimating lens 61 strikes the reflection mirror 55 through a beam splitter 62, a lens 63, the dichroic prism 74, and the lens 75. The beam splitter 62 is a prism that exhibits polarizing characteristics to transmission and reflectivity. The beam splitter 62 efficiently transmits the light beam outgoing from the laser diode 60 and efficiently reflects the light beam reflected from the disc.

In this configuration, the lens 63 can be driven in the optical axial direction. The lens 63 combined with the lens 75 can change divergence and convergence of the light beam incident on the objective lens, thereby correcting relative defocusing caused by the recording layers and the guide layer.

The light beam reflected from the reflection mirror 55 passes through the quarter wave plate 56 and is focused onto the guide layer 500 on the optical disc illustrated in FIG. 17 through the objective lens 2 provided in the actuator 5. The light beam reflected from the guide layer 500 is incident on a detecting lens 64 through the objective lens 2, the quarter wave plate 56, the reflection mirror 55, the lens 75, the dichroic prism 74, the lens 63, and the beam splitter 62. Since astigmatism is provided for the light beam through the detecting lens 64, the focusing error signal and the tracking error signal are detected by a detector 65 according to an astigmatic method.

An information recording method according to the present embodiment will be described below.

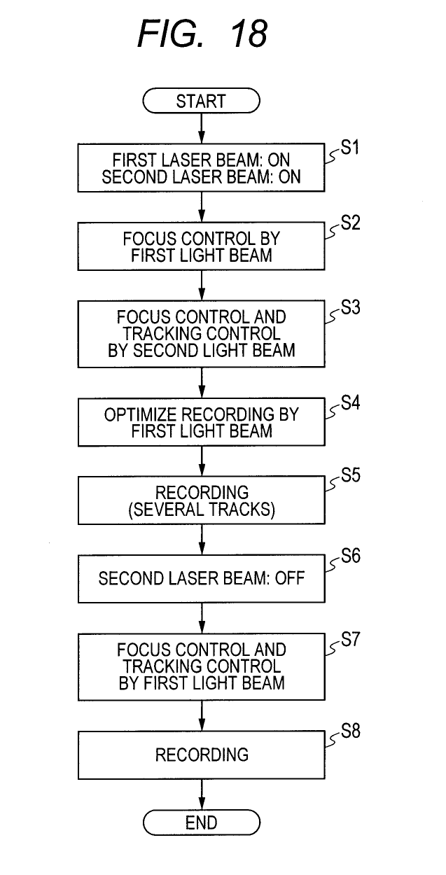

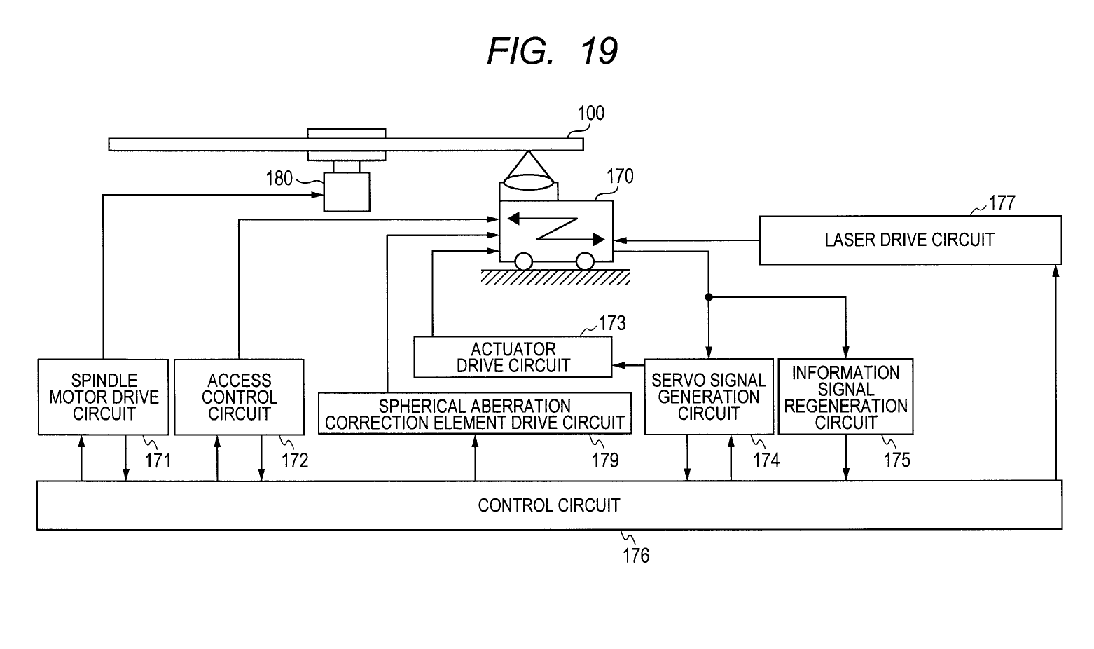

FIG. 18 is a flowchart showing the steps of the information recording method. First, the disc is driven to turn on the laser diode 50 (first light beam) and the laser diode 60 (second light beam) (S1). The objective lens 2 is then driven in the optical axial direction with the first light beam to control focusing on the recording layer (S2). The lens 63 is then driven in the optical axial direction with the second light beam to control focusing on the guide layer and the objective lens 2 is driven in the radial direction to control tracking on guide tracks on the guide layer (S3). After that, a predetermined region of the recording layer of the disc is used with the first light beam to optimize recording conditions including a recording power, a spherical aberration correction through the lens 53, defocusing, and an inclination of the objective lens (S4). The light beam is then moved to the predetermined region of the recording layer of the disc to perform recording on several tracks under the optimum recording conditions (S5). The laser diode 60 (second light beam) is then turned off (S6), the objective lens 2 is driven in the optical axial direction to control focusing of the first light beam onto the recording layer, and then the objective lens is driven in the radial direction to control tracking of the first light beam on the recording marks of the recording layer (S7). Recording is performed in this state (S8).

In the present embodiment, a servo signal can be generated using the recorded marks. Thus, the recording marks formed in S5 enable continuous recording. A basic method of detecting the tracking error signal is similar to that of the first embodiment.

The structure of the optical disc can be simplified by the information recording method using the optical disc apparatus including the optical pickup device according to the present embodiment, achieving quite an inexpensive multi layer disc. The present embodiment is different from the first to third embodiments in that the recording marks do not need to be recorded beforehand on the disc and only the at least one guide layer including the guide grooves is necessary.

Since the three spots are used in the present embodiment, recording can be performed only in one direction, that is, from the inner edge to the outer edge or from the outer edge to the inner edge. For example, the guide layer includes two layers, spiral structures in two layers are opposed to each other, the diffraction efficiency of the grating 11 is expressed as zero-order diffracted light: +1^{st}-order diffracted light: −1^{st}-order diffracted light=10:1:1, and five beams are located on the disc as illustrated in FIG. 7, which enables recording in both directions. The zero-order diffracted light from the grating 11 forms the spot 20a (main beam), the +1^{st}-order diffracted light from the region I forms the spot 20b (sub beam), the −1^{st}-order diffracted light from the region I forms the spot 20d (sub beam), the +1^{st}-order diffracted light from the region II forms the spot 20c (sub beam), and the −1^{st}-order diffracted light from the region II forms the spot 20e (sub beam). A distance D1 between the spot 20b and the spot 20c (spots 20d and 20e) in the radial direction of the disc is expressed by (n+1/2)T (n is an integer not smaller than 0) where T is a distance between the recording marks in the radial direction. A distance D2 between the center of the spots 20b and 20c (the spot 20a and the center of the spots 20d and 20e) and the spot 20a in the radial direction of the disc is expressed by (m+1)T/2 (m is an integer not smaller than 0).

A signal may be detected using the detection part illustrated in FIG. 8. The zero-order diffracted light 20a from the grating 11 is incident on the quadrant regions a, b, c, and d of the detection part, the +1^{st}-order diffracted light 20b and the +1^{st}-order diffracted light 20c are incident on two equal regions e and f of the detection part, and the −1^{st}-order diffracted light 20d and the −1^{st}-order diffracted light 20e are incident on the two equal regions g and h of the detection part. Signals A, B, C, D, E, F, G, and H obtained from the regions a, b, c, d, e, f, g, and h are calculated to generate the focusing error signal, the tracking error signal, and the RF signal as below.

FES=(A+C)−(B+D)

TES=G−H

RF=A+B+C+D Numerical Formula 1

In this case, recording from the inner edge to the outer edge is shown. For example, recording from the outer edge to the inner edge requires the following operations:

FES=(A+C)−(B+D)

TES=E−F

RF=A+B+C+D Numerical Formula 2

The above operations can respond to recording in both directions. The lens 53 is driven in the optical axial direction in the spherical aberration correction but the method of spherical aberration correction is not limited in the present embodiment. For example, a beam expander may be incorporated into the optical system. Moreover, in the present embodiment, the focusing error signal is detected by the astigmatic method but the method of detecting the focusing error signal is not limited to the astigmatic method. The detection method may be combined with a focusing error signal detection method, e.g., a knife-edge method and a spot-size method. Furthermore, the wavelength of the laser diode and the numerical aperture of the objective lens are not limited to those of the present embodiment.

The grating according to the fourth embodiment of the present invention is not limited to the grating in FIG. 2. The same effect can be obtained by arranging three or five beams on the disc with the spot distances D1 and D2.

Furthermore, tracking control according to the present embodiment is not limited to tracking control along inner recording marks. Tracking control may be performed along further inner recording marks as long as the corresponding recording marks have been recorded on the disc. In this case, m may be changed.

Recording may be performed from the inner edge to the outer edge or from the outer edge to the inner edge. The spot layout on the disc according to the present embodiment is identical to that of the first embodiment. The spot layout on the disc may be identical to those of the second and third embodiments. In this case, the same detection method and the same signal calculating method as in the second and third embodiments may be used in the spot layout on the disc.

The present embodiment described the method of detecting the tracking error signal during recording. In the case of reproduction, the detection method of the present embodiment may be used or tracking control may be performed using the main beam with a DPD signal. Moreover, the guide layer may be irradiated with the second light beam during recording to detect a rotation synchronizing signal through guide tracks. This enables stable recording in synchronization with the rotations of the disc. Furthermore, the present embodiment described an example of the recording layer including three layers (400A, 400B, 400C). The present embodiment is not, however, limited to this configuration.

### Fifth Embodiment

A fifth embodiment will describe an optical reproducing apparatus including an optical pickup device 170.

FIG. 19 illustrates a schematic configuration of the optical reproducing apparatus. The optical pickup device 170 has a mechanism that can be driven in the radial direction of an optical disc 100. The position of the optical pickup device 170 is controlled in response to an access control signal from an access control circuit 172.

A predetermined laser driving current is supplied from a laser drive circuit 177 to a laser diode in the optical pickup device 170 and a laser beam having a predetermined light quantity is emitted from the laser diode during reproduction. The laser drive circuit 177 may be incorporated into the optical pickup device 170.

A signal outputted from a detector 10 in the optical pickup device 170 is transmitted to a servo signal generation circuit 174 and an information signal regeneration circuit 175. In the servo signal generation circuit 174, servo signals such as the focusing error signal, the tracking error signal, and a tilt control signal are generated based on the signal from the detector 10 and then an actuator in the optical pickup device 170 is driven through the actuator drive circuit 173 based on the signals to control the position of the objective lens. The servo signal generation circuit 174 has the function of switching a tracking error signal operation between recording from the inner edge to the outer edge and recording from the outer edge to the inner edge.

In the information signal regeneration circuit 175, an information signal recorded on the optical disc 100 is reproduced based on the signal from the detector 10.

Some of the signals obtained by the servo signal generation circuit 174 and the information signal regeneration circuit 175 are transmitted to a control circuit 176. The control circuit 176 is connected to, for example, a spindle motor drive circuit 171, the access control circuit 172, the servo signal generation circuit 174, the laser drive circuit 177, and a spherical aberration correction element drive circuit 179. The control circuit 176 controls the rotations of a spindle motor 180 for rotating the optical disc 100, controls an access direction and an access position, servo-controls an objective lens, controls a quantity of light from a laser diode in the optical pickup device 170, and corrects a spherical aberration caused by a difference in the substrate thickness of the disc.

### Sixth Embodiment

A sixth embodiment will describe an optical recording/reproducing apparatus including an optical pickup device 170.

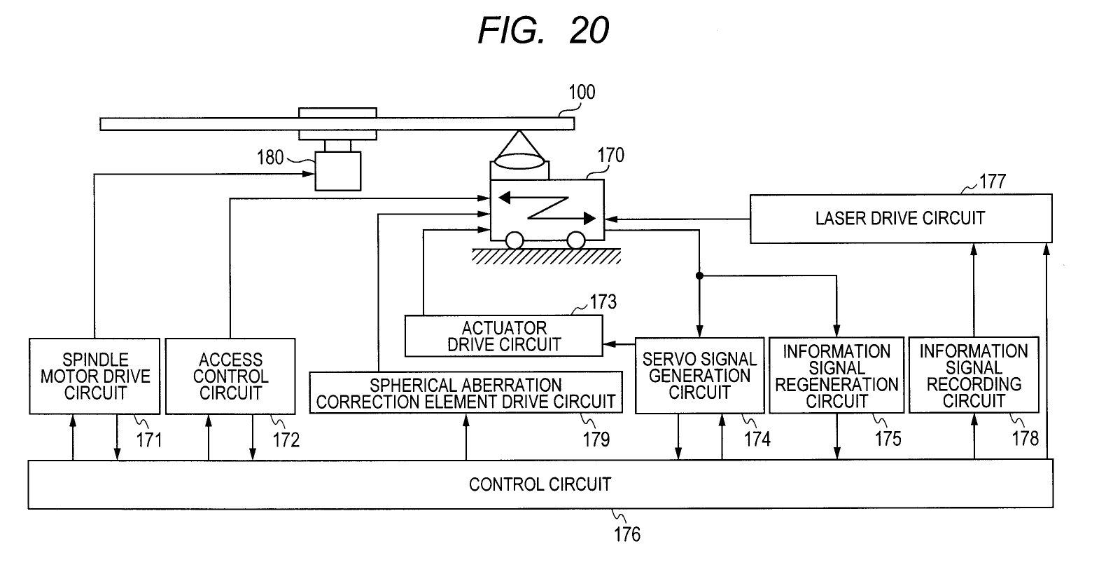

FIG. 20 illustrates a schematic configuration of the optical recording/reproducing apparatus. This apparatus is different from the optical information reproducing apparatus in FIG. 19 in that an information signal recording circuit 178 is provided between a control circuit 176 and a laser drive circuit 177 and the apparatus has the function of controlling the driving of the laser drive circuit 177 based on a recording control signal from the information signal recording circuit 178 and writing desired information onto an optical disc 100.

The present invention covering various modifications is not limited to the foregoing embodiments. The foregoing embodiments were described in detail to illustrate the present invention but the present invention does not necessarily include all the illustrated configurations of the embodiments. The configuration of one of the embodiments may be partially replaced with the configurations of the other embodiments or the configuration of one of the embodiments may further include the configurations of the other embodiments. The configurations of the embodiments may further include other configurations, may be partially deleted, or may be partially replaced with other configurations.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical pickup device that emits a light beam to an optical disc serving as a recording medium and detects a signal based on a recording mark included in the optical disc,
the optical pickup device comprising:
a laser light source that emits the light beam;
a splitter that splits the light beam from the laser light source into at least three light beams: a main beam, a first sub beam, and a second sub beam;
an objective lens that condenses the at least three light beams split by the splitter and forms at least three light spots on the optical disc; and
a detector that detects the at least three light beams reflected from the optical disc and generates detection signals,
wherein the light spot of the first sub beam and the light spot of the second sub beam are emitted to the optical disc so as to be located inside or outside the light spot of the main beam on the optical disc, and
a tracking error signal for allowing the light spots to scan the optical disc is generated using the detection signals obtained by detecting the first sub beam and the second sub beam on the detector.

2. The optical pickup device according to claim 1,
wherein the tracking error signal is generated by determining a difference between a first detection signal obtained by detecting the first sub beam and a second detection signal obtained by detecting the second sub beam.

3. The optical pickup device according to claim 1,
wherein a distance between the light spot of the first sub beam and the light spot of the second sub beam in a radial direction of the optical disc is approximately (n+1/2)T, and
a distance between a center of the light spot of the first sub beam and the light spot of the second sub beam and the light spot of the main beam in the radial direction of the optical disc is approximately (m+1) T/2 where T is a distance between the recording marks in the radial direction of the optical disc and n and m are integers not smaller than 0.

4. An optical pickup device that emits a light beam to an optical disc serving as a recording medium and detects a signal based on a recording mark included in the optical disc,
the optical pickup device comprising:
a laser light source that emits the light beam;
a splitter that splits the light beam from the laser light source into at least five light beams: a main beam, a first sub beam, a second sub beam, a third sub beam, and a fourth sub beam;
an objective lens that condenses the at least five light beams split by the splitter and forms at least five light spots on the optical disc; and
a detector that detects the light beams reflected from the optical disc and generates detection signals,
wherein the light spot of the first sub beam and the light spot of the second sub beam are emitted to the optical disc so as to be located inside the light spot of the main beam on the optical disc,
the light spot of the third sub beam and the light spot of the fourth sub beam are emitted to the optical disc so as to be located outside the light spot of the main beam on the optical disc, and
a tracking error signal for allowing the light spots to scan the optical disc is generated using the detection signals obtained by detecting the first sub beam and the second sub beam on the detector or the detection signals obtained by detecting the third sub beam and the fourth sub beam.

5. The optical pickup device according to claim 4,
wherein the tracking error signal is generated by determining a difference between a first detection signal obtained by detecting the first sub beam and a second detection signal obtained by detecting the second sub beam or a difference between a third detection signal obtained by detecting the third sub beam and a fourth detection signal obtained by detecting the fourth sub beam.

6. The optical pickup device according to claim 4,
wherein a distance between the light spot of the first sub beam and the light spot of the second sub beam in a radial direction of the optical disc is approximately (n+1/2) T,
a distance between a center of the light spot of the first sub beam and the light spot of the second sub beam and the light spot of the main beam in the radial direction of the optical disc is approximately (m+1) T/2, and
a distance between the center of the light spot of the third sub beam and the light spot of the fourth sub beam and the light spot of the main beam in the radial direction of the optical disc is approximately (m+1) T/2 where T is a distance between the recording marks in the radial direction of the optical disc and n and m are integers not smaller than 0.

7. The optical pickup device according to claim 4,
wherein the tracking error signal is generated from the detection signals obtained by detecting the first sub beam and the second sub beam in the case where the optical pickup device scans from an inner edge to an outer edge of the optical disc, and
the tracking error signal is generated from the detection signals obtained by detecting the third sub beam and the fourth sub beam in the case where the optical pickup device scans from the outer edge to the inner edge of the optical disc.

8. The optical pickup device according to claim 4,
wherein the optical pickup device receives a control signal from an optical disc apparatus including the optical pickup device, the control signal instructing a scanning direction in a radial direction of the optical disc, and
it is determined, based on the control signal, whether the tracking error signal supplied to the optical disc apparatus is to be generated using the detection signals obtained by the first sub beam and the second sub beam or the detection signals obtained by detecting the third sub beam and the fourth sub beam.

9. An optical pickup device that emits a light beam to an optical disc serving as a recording medium and detects a signal based on a recording mark included in the optical disc,
the optical pickup device comprising:
a laser light source that emits the light beam;
a splitter that splits the light beam from the laser light source into at least five light beams: a main beam, a first sub beam, a second sub beam, a third sub beam, and a fourth sub beam;
an objective lens that condenses the at least five light beams split by the splitter and forms at least five light spots on the optical disc; and
a detector that detects the light beams reflected from the optical disc and generates detection signals,
wherein the light spot of the first sub beam and the light spot of the second sub beam are emitted to the optical disc so as to be located inside the light spot of the main beam on the optical disc,
the light spot of the third sub beam and the light spot of the fourth sub beam are emitted to the optical disc so as to be located outside the light spot of the main beam on the optical disc, and
the detector outputs the detection signals obtained by detecting the first sub beam and the second sub beam or the detection signals obtained by detecting the third sub beam and the fourth sub beam, as signals for generating a tracking error signal for allowing the light spots to scan the optical disc.

10. The optical pickup device according to claim 9, wherein a distance between the light spot of the first sub beam and the light spot of the second sub beam in a radial direction of the optical disc is approximately (n+1/2) T,
a distance between the light spot of the third sub beam and the light spot of the fourth sub beam in the radial direction of the optical disc is approximately (n+1/2)T,
a distance between a center of the light spot of the first sub beam and the light spot of the second sub beam and the light spot of the main beam in the radial direction of the optical disc is approximately (m+1)T/2, and
a distance between the center of the light spot of the third sub beam and the light spot of the fourth sub beam and the light spot of the main beam in the radial direction of the optical disc is approximately (m+1)T/2 where T is a distance between the recording marks in the radial direction of the optical disc and n and m are integers not smaller than 0.

11. The optical pickup device according to claim 9,
wherein the detection signals obtained by detecting the first sub beam and the second sub beam are outputted as signals for generating the tracking error signal in the case where the optical pickup device scans from an inner edge to an outer edge of the optical disc, and
the detection signals obtained by detecting the third sub beam and the fourth sub beam are outputted as signals for generating the tracking error signal in the case where the optical pickup device scans from the outer edge to the inner edge of the optical disc.

12. The optical pickup device according to claim 9,
wherein the optical pickup device receives a control signal from an optical disc apparatus including the optical pickup device, the control signal instructing a scanning direction in a radial direction of the optical disc, and
it is determined, based on the control signal, whether the detection signals obtained by the first sub beam and the second sub beam or the detection signals obtained by detecting the third sub beam and the fourth sub beam are to be outputted to the optical disc apparatus as signals for generating the tracking error signal.

13. An optical pickup device that emits a light beam to an optical disc serving as a recording medium and detects a signal included in the optical disc,
the optical pickup device comprising:
a laser light source that emits the light beam;
a splitter that splits the light beam from the laser light source into at least three light beams: a main beam, a first sub beam, and a second sub beam,
an objective lens that condenses the at least three light beams split by the splitter and forms at least three light spots on the optical disc; and
a detector that detects the light beams reflected from the optical disc and generates detection signals,
wherein the light spot of the first sub beam and the light spot of the second sub beam scan a recorded region of the optical disc when the light spot of the main beam scans an unrecorded region of the optical disc to record a signal.

14. The optical pickup device according to claim 1, wherein the splitter is a grating divided into at least two regions.

15. An optical disc apparatus comprising:
the optical pickup device according to claim 9;
a laser drive circuit that drives the laser light source included in the optical pickup device;
a servo signal generation circuit that generates a focusing error signal and the tracking error signal by using the detection signals detected by the detector included in the optical pickup device; and
an information signal regeneration circuit that regenerates an information signal recorded on the optical disc.

16. An optical disc apparatus comprising:
the optical pickup device according to claim 9;
a laser drive circuit that drives the laser light source included in the optical pickup device;
a servo signal generation circuit that generates a focusing error signal and the tracking error signal by using the detection signals detected by the detector included in the optical pickup device; and
an information signal regeneration circuit that regenerates an information signal recorded on the optical disc,
wherein methods of calculating the tracking error signal are switched according to a scanning direction of the optical pickup device in a radial direction of the optical disc.

17. An information recording method for an optical disc serving as a recording medium, comprising the steps of:
irradiating the optical disc with a plurality of light spots including at least a first spot, a second spot, and a third spot; and
controlling tracking on the optical disc by means of the second spot and the third spot while forming recording marks for recording of information by means of the first spot.
